(19) United States
(12) Patent Application Publication
(10) Pub. No.: US 2017/0132165 A1
(43) Pub. Date: May 11, 2017

(54) RELAY APPARATUS AND RELAY METHOD

(71) Applicant: FUJITSU LIMITED, Kawasaki-shi (JP)

(72) Inventor: Hiromiki UEKURI, Kawasaki (JP)

(73) Assignee: FUJITSU LIMITED, Kawasaki-shi (JP)

(21) Appl. No.: 15/333,680

(22) Filed: Oct. 25, 2016

(30) Foreign Application Priority Data
Nov. 5, 2015 (JP) 2015-217566

(51) Int. Cl. G06F 13/364; G06F 13/40; H04L 1/16; G06F 13/42

(52) U.S. Cl. CPC G06F 13/364; G06F 13/4282; G06F 13/404; H04L 1/16

(57) ABSTRACT

There is provided a relay apparatus configured to relay data transmitted on a first bus coupled to a bus controller and a second bus coupled to a device, the relay apparatus includes: a memory; and a processor coupled to the memory and the processor configured to: control a switch to couple or separate the first bus and the second bus, and transmit first data for indicating a bus access start to the second bus before coupling the first bus and the second bus.

### CROSS-REFERENCE TO RELATED APPLICATION

This application is based upon and claims the benefit of priority of the prior Japanese Patent Application No. 2015-217566, filed on Nov. 5, 2015, the entire contents of which are incorporated herein by reference.

### FIELD

The embodiments discussed herein are related to a relay apparatus and relay method.

### BACKGROUND

For example, in a two-wire serial bus similar to an inter-integrated circuit (I2C) interface, when a bus controller (master) accesses a slave device connected to a bus, a slave address provided to the slave device is transmitted onto the bus. The slave address is a unique address allocated for each slave device. When the slave address is specified by seven bits, at least any part of bits (for example, lower three bits) among seven bits of the slave address may be changeable, depending on the component.

When the lower three bits in the slave address of seven bits are changed, for example, three pins of device pins are associated with the lower three bits of the slave address, and pull-up or pull-down using an external resistance is performed on each of these pins, thereby setting each bit at “1” or “0”.

In the two-wire serial bus similar to the I2C interface, if a slave address becomes redundant because devices having the same slave address are connected, the plurality of these devices having the same slave address respond simultaneously. This disables normal reading and writing from and to the slave devices. Therefore, in the bus, redundant slave addresses are not allowed.

Thus, when a plurality of same devices are used in a system and, for example, lower three bits of a slave address are changeable, the value of the lower three bits of the slave address of each device is changed so as not to be redundant. This allows connection of up to eight (=2³) same devices on the same bus. By contrast, when a plurality of devices with their device addresses fixed and unchangeable are used or when nine or more devices where lower three bits are changeable are used, a bus multiplexer is used.

Japanese Laid-open Patent Publication Nos. 2006-268267, 2002-215566, and 11-96090 are examples of related art.

### SUMMARY

According to an aspect of the invention, a relay apparatus is configured to relay data transmitted on a first bus coupled to a bus controller and a second bus coupled to a device, the relay apparatus includes: a memory; and a processor coupled to the memory and the processor configured to: control a switch to couple or separate the first bus and the second bus, and transmit first data for indicating a bus access start to the second bus before coupling the first bus and the second bus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram exemplarily depicting the structure of a bus system as an exemplary embodiment;

FIG. 2 is a block diagram depicting the functional structure of a bus connection control circuit of the bus system as an exemplary embodiment;

FIG. 3A to FIG. 3D are timing diagrams exemplarily depicting clock signals and data signals in the bus system as an exemplary embodiment;

FIG. 4 is a diagram depicting an example of the connection structure of the bus system as an exemplary embodiment;

FIG. 5 is a diagram depicting another example of the connection structure of the bus system as an exemplary embodiment;

FIG. 6 is a flowchart for describing a process by the bus connection control circuit of the bus system as an exemplary embodiment; and

FIG. 7 is a diagram exemplarily depicting a bus system of related art.

### DESCRIPTION OF EMBODIMENTS

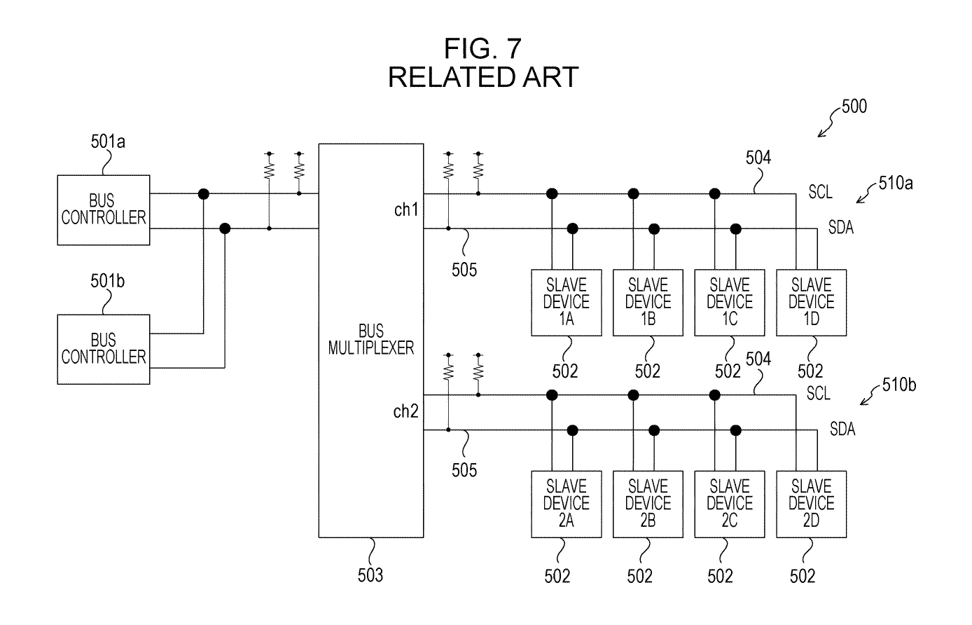

FIG. 7 is a diagram exemplarily depicting a bus system of related art. A bus system 500 depicted in this FIG. 7 is an I2C bus system, and includes a bus multiplexer 503. To this bus multiplexer 503, two serial buses 510a and 510b are connected. More specifically, the bus multiplexer 503 includes two channels (ch1 and ch2), and the serial bus 510a is connected to ch1 and the serial bus 510b is connected to ch2.

The serial buses 510a and 510b each include a signal line 504 for transmission of a clock signal SCL and a signal line 505 for transmission of a data signal SDA. Note that, in the following, while the reference character 510a or 510b is used as a reference character indicating a serial bus when one of a plurality of serial buses is specified, a reference character 510 is used when any serial bus is referred to.

Also, to the bus multiplexer 503, two bus controllers 501a and 501b are connected. The bus controllers 501a and 501b each access a slave device 502 via the bus multiplexer 503 for causing a process to be performed. Note that, in the following, while the reference character 501a or 501b is used as a reference character indicating a bus controller when one of a plurality of bus controllers is specified, a reference character 501 is used when any bus controller is referred to. Also in the following, the bus controllers may be referred to as bus masters.

The bus system 500 depicted in FIG. 7 has a multi-master structure including the plurality of bus masters 501. To the serial bus 510a, slave devices 502 denoted as reference characters 1A, 1B, 1C, and 1D are connected. To the serial bus 510b, slave devices 502 denoted as reference characters 2A, 2B, 2C, and 2D are connected.

In this bus system 500 depicted in FIG. 7, the bus multiplexer 503 divides a bus into two serial buses 510a and 510b as a tree structure. By switching the buses by selecting a channel of the bus multiplexer 503, the bus controllers 501a and 501b access any of the slave devices 1A, 1B, 1C, 1D, 2A, 2B, 2C, and 2D, thereby allowing use of the plurality of the slave devices.

Meanwhile, in this bus system 500 of related art in the multi-master structure including the bus multiplexer 503 as depicted in FIG. 7, one bus controller 501 accesses, for example, the slave device 1A, by using the following procedure. That is, the bus controller 501 accesses the bus multiplexer 503 with an access by a first bus acquisition, selects ch1 for switching, and then accesses the target slave device 1A with an access by a second bus acquisition.

In the multi-master bus system 500 of related art, it is assumed, for example, that one bus controller 501 (for example, the bus controller 501a) selects ch1 of the bus multiplexer 503 for switching with a first access in order to access the slave device 1A. Then, before the bus controller 501a accesses the slave device 1A with a second access, another bus controller 501b may acquire a bus and access the bus multiplexer 503 to select ch2 for switching in order to access the slave device 2A.

In this case, even if the bus controller 501a is supposed to cause the bus multiplexer 503 to switch to ch1, the bus multiplexer 503 is actually switched to ch2 by the bus controller 501b. Therefore, even if the bus controller 501a tries to access the slave device 1A, the bus controller 501a is unable to access the slave device 1A. Moreover, also in a bus system with a single master structure including one bus controller, a phenomenon similar to the above may occur when firmware operates in a multitasking manner and one task accesses the slave device 1A and another task accesses the slave device 2A.

Therefore, in the bus system 500 of related art, an exclusive process is desired without switching of the channel of the bus multiplexer 503 due to a process by another bus controller or task process.

In the following, with reference to the drawings, embodiments of a relay apparatus and relay method with a technique allowing a reliable access to a device to be attained are described. However, the embodiments described below are merely examples, and are not intended to exclude various modification examples and technical applications not clearly described in the embodiments. That is, the embodiments may be implemented as variously modified within a scope not deviating from the gist of the embodiments. Also, each drawing is not meant to include only the components depicted in the drawing but may include another function and so forth.

[Structure]

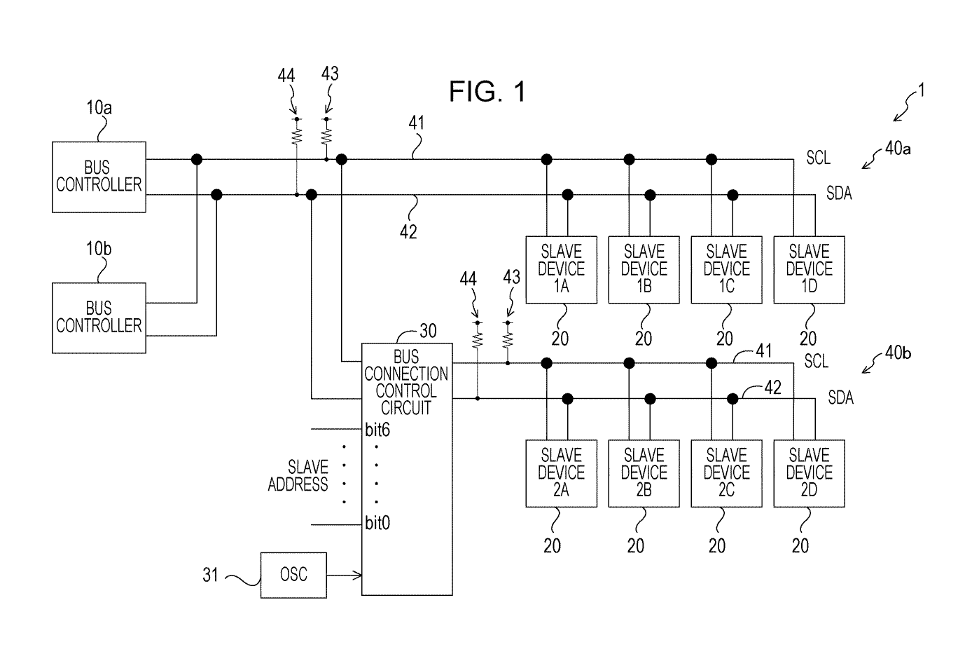

FIG. 1 is a diagram exemplarily depicting the structure of a bus system 1 as an exemplary embodiment. The bus system 1 includes, as depicted in FIG. 1, a serial bus 40a and a serial bus 40b. The serial buses 40a and 40b are two-wire bus systems each including a clock signal line 41 and a data signal line 42. In the following, an example is described in which the present bus system 1 is an I2C bus.

The clock signal line 41 is raised (pulled up) by a pull-up resistor 43 to a H (high) level, and the data signal line 42 is raised (pulled up) by a pull-up resistor 44 to a H (high) level. The clock signal line 41 is for transmission of a clock signal SCL, and the data signal line 42 is for transmission of a data signal SDA. At one end side (left side in FIG. 1) of the serial bus 40a, bus controllers 10a and 10b are connected.

The bus controllers 10a and 10b are control apparatuses which access a slave device 20 (described further below) connected to the bus system 1 to cause various processes. In the following, while the reference character 10a or 10b is used as a reference character indicating a bus controller when one of a plurality of bus controllers is specified, a reference character 10 is used when any bus controller is referred to. Also in the following, the bus controllers may be referred to as bus masters or masters.

The bus controller 10 transmits first transmission data, second transmission data, and third transmission data when accessing the slave device 20 connected to the serial bus 40b via a bus connection control circuit 30.

The first transmission data includes a slave address set to a bus connection control circuit 30, which will be described further below, and a command indicative of specifying write (+Write).

The second transmission data includes the slave address of the slave device 20 to be accessed by the bus controller 10 and a command indicative of performing read (+Read) or a command indicative of performing write (+Write). Note that the command indicative of performing read or write may be referred to as +R/W.

The third transmission data is data to be transmitted to the slave device 20 to be accessed (process target data). Also, the bus controller 10 transmits the second transmission data and the third transmission data when accessing the slave device 20 connected to the serial bus 40a. At the other end side (right side in FIG. 1) of the serial bus 40a, a plurality of (four in the example depicted in FIG. 1) slave devices 20 are connected. In the following, in the serial bus 40a, the side to which the bus controllers 10a and 10b are connected is referred to as an upstream side, and the side to which the slave devices 20 are connected is referred to as a downstream side. Also in the following, these slave devices 20 connected to the serial bus 40a may be denoted as reference characters 1A, 1B, 1C, and 1D.

At a position on the upstream side of the plurality of slave devices 20 in the serial bus 40a, the serial bus 40b is connected so as to be branched from this serial bus 40a. Also in this serial bus 40b, a plurality of (four in the example depicted in FIG. 1) slave devices 20 are connected on a side opposite to the side connected to the serial bus 40a. In the serial bus 40b, the side connected to the bus controller 10a is referred to as an upstream side, and the side to which the slave devices 20 are connected is referred to as a downstream side. In the following, the slave devices 20 connected to the serial bus 40b may be denoted as reference characters 2A, 2B, 2C, and 2D.

The slave devices 20 are, for example, non-volatile memories, light emitting diodes (LEDs), various sensors, log storage electrically erasable programmable read-only memories (EEPROMs), and so forth, attaining various functions by following control by the bus controllers 10a and 10b.

Also in the serial bus 40b, the bus connection control circuit 30 is disposed on the upstream side of the slave devices 20.

The bus connection control circuit 30 controls connection between a portion on the upstream side and a portion on the downstream side of the bus connection control circuit 30 in the serial bus 40b. With this, in the serial bus 40b, the slave devices 2A, 2B, 2C, and 2D are connected to the bus controllers 10a and 10b via the bus connection control circuit 30. In the following, in the serial bus 40b, the upstream side of the bus connection control circuit 30 (first bus) may be referred to as a previous stage, and the downstream side of the bus connection control circuit 30 (second bus) may be referred to as a subsequent stage. The bus connection control circuit 30 controls connection between the previous stage and the subsequent stage of the bus connection control circuit 30 in the serial bus 40b. The bus connection control circuit 30 functions as a relay apparatus which relays the first bus as the previous stage and the second bus as the subsequent stage of the bus connection control circuit 30 in the serial bus 40b.

To the bus connection control circuit 30, a clock oscillated from a clock oscillator (OSC) 31 is inputted, and the bus connection control circuit 30 operates in synchronization with this clock.

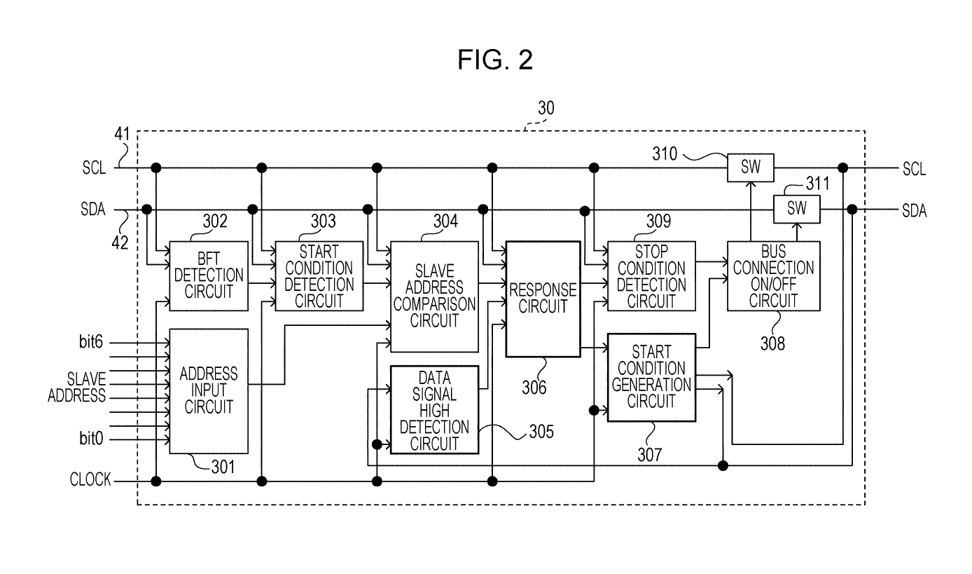

FIG. 2 is a block diagram depicting the functional structure of the bus connection control circuit 30 of the bus system 1 as an exemplary embodiment.

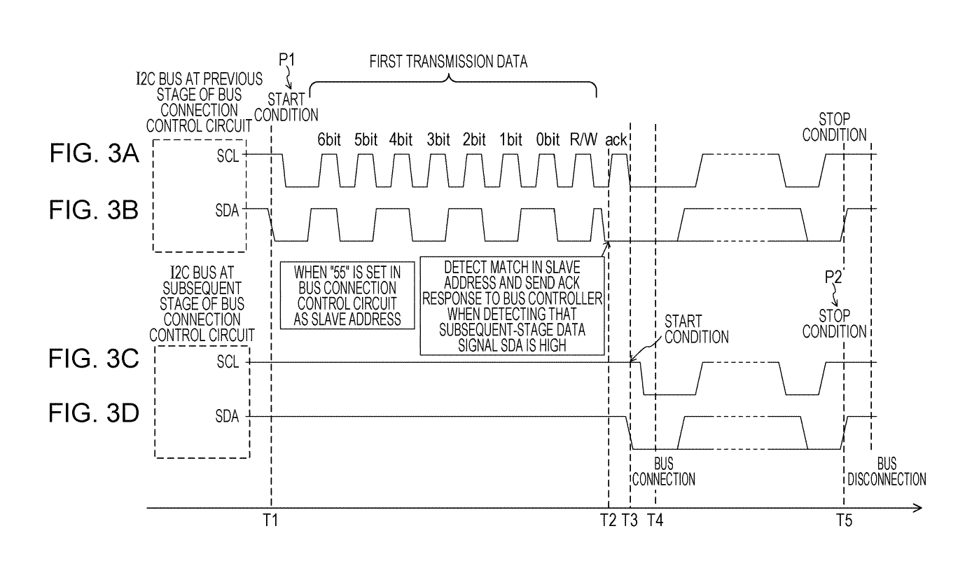

FIG. 3A to FIG. 3D are sequence diagrams exemplarily depicting the clock signals SCL and the data signals SDA in the bus system 1. FIG. 3A depicts the clock signal SCL at the previous stage of the bus connection control circuit 30, and FIG. 3B depicts the data signal SDA at the previous stage of the bus connection control circuit 30. FIG. 3C depicts the clock signal SCL at the subsequent stage of the bus connection control circuit 30, and FIG. 3D depicts the data signal SDA at the subsequent stage of the bus connection control circuit 30.

As depicted in FIG. 2, the bus connection control circuit 30 includes an address input circuit 301, a bus free time (BFT) detection circuit 302, a start condition detection circuit 303, a slave address comparison circuit 304, a data signal high detection circuit 305, a response circuit 306, a start condition generation circuit 307, a bus connection ON/OFF circuit 308, a stop condition detection circuit 309, and switches (SWs) 310 and 311.

To the bus connection control circuit 30, an address (slave address) to be used by the bus connection control circuit 30 is set in advance. This slave address is set as a unique address which does not overlap the slave addresses of other slave devices 20 and so forth in the bus system 1. The bus connection control circuit 30 includes external input pins of, for example, seven bits from bit0 to bit6. A slave address is set by respectively associating these external input pins with the slave address represented by a binary value (0/1) and performing pull-up or pull-down.

For example, when “55 (hexadecimal number)” is set as a slave address, a value of seven bits “1010101” representing this “55” as a binary number is set to bit0 to bit6 as a slave address. Note that this setting of a slave address to the external input pins may be performed by the bus controller 10 or the like or by an operator, service engineer, or the like, and may be implemented as being variously modified.

At power-up of the bus connection control circuit 30, the address input circuit 301 fetches the value of the slave address set by the external input pins.

The BFT detection circuit 302 monitors the respective voltage levels of the clock signal line 41 and the data signal line 42. By detecting that the voltage levels of both of the clock signal line 41 and the data signal line 42 are in a H level state for a predetermined time (bus free time between stop and start conditions (Tbuf)) (BFT detection), the BFT detection circuit 302 detects an interval between bus accesses.

The start condition detection circuit 303 detects a start condition of the I2C bus. The start condition of the I2C bus represents a start of an I2C bus access. When the clock signal SCL is in a H level state, upon detecting a state in which the data signal SDA falls from a H level to a L level (refer to a reference character P1 in FIG. 3A and FIG. 3B), the start condition detection circuit 303 detects the state as a start condition of the I2C bus.

When the BFT detection circuit 302 detects an interval between bus accesses, the start condition detection circuit 303 detects an occurrence of a start condition, thereby detecting a start of an I2C bus access by the bus controller 10. In other words, this start condition is outputted from the bus controller 10.

The stop condition detection circuit 309 detects a stop condition of the I2C bus. The stop condition of the I2C bus represents an end of the I2C bus access. When the clock signal SCL is in a H level state, the stop condition detection circuit 309 detects a state in which the data signal SDA rises from a L level to a H level (refer to a reference character P2 in FIG. 3C and FIG. 3D) as a stop condition. In other words, this stop condition is outputted from the bus controller 10. When the access from the bus controller 10 to the slave device 20 ends and a stop condition occurs due to control of the bus controller 10, the stop condition detection circuit 309 detects this stop condition.

The slave address comparison circuit 304 monitors the clock signal SCL and the data signal SDA, compares the slave address included in the first transmission data transmitted from the bus controller 10 and the address set by a slave address setting input, and determines whether these addresses are identical. That is, the slave address comparison circuit 304 functions as a comparing unit which compares the address included in the first transmission data and the address set to the bus connection control circuit 30.

After the start condition detection circuit 303 detects a start condition, the slave address comparison circuit 304 compares the slave address of the first transmission data and the address set by the slave address setting input.

The data signal high detection circuit 305 detects whether the data signal SDA at the subsequent stage of the bus connection control circuit 30 is at a H level. When the slave address comparison circuit 304 determines that the slave address of the first transmission data and the address set by the slave address setting input match, the data signal high detection circuit 305 determines whether the data signal SDA is at an H level. That is, the data signal high detection circuit 305 functions as a checking unit which checks a data signal level in the second bus.

When the data signal high detection circuit 305 determines that the data signal SDA at the subsequent stage of the bus connection control circuit 30 is at a L level, the response circuit 306 outputs (sends) a NACK signal (negative acknowledgement notification) to the bus controller 10. That is, the response circuit 306 functions as a response processing unit which issues a negative acknowledgement notification to the serial bus (first bus) 40 at the previous stage when the data signal level in the data signal line 42 of the serial bus 40 at the subsequent stage of the bus connection control circuit 30 is a low level.

When receiving a NACK signal from the response circuit 306, the bus controller 10 ends the access to the slave device 20 at the subsequent stage of the bus connection control circuit 30. This may cause the bus controller 10 not to be connected to the serial bus 40 falling to a L level and avoid an inability to control the slave device 20 from the bus controller 10.

Also, when the data signal high detection circuit 305 determines that the data signal SDA at the subsequent stage of the bus connection control circuit 30 is at a H level, the response circuit 306 outputs (sends) an ACK signal to the bus controller 10.

The start condition generation circuit 307 generates a start condition on a slave device 20 side at the subsequent stage of the bus connection control circuit 30. When the following conditions (1) to (3) are satisfied, the start condition detection circuit 303 generates a start condition on the slave device 20 side at the subsequent stage of the bus connection control circuit 30 before the bus connection ON/OFF circuit 308, which will be described further below, connects the serial bus (first bus) 40 at the previous stage of the bus connection control circuit 30 and the serial bus (second bus) 40 at the subsequent stage thereof.

Condition (1): The slave address comparison circuit 304 determines that the slave address of the first transmission data matches the address set to the bus connection control circuit 30 by the slave address setting input.

Condition (2): The data signal high detection circuit 305 detects that the data signal SDA at the subsequent stage of the bus connection control circuit 30 is at a H level.

Condition (3): The response circuit 306 sends an ACK signal to a bus controller 10 side.

This allows the slave device 20 at the subsequent stage of the bus connection control circuit 30 to know that an I2C bus access starts from the bus controller 10. That is, the start condition generation circuit 307 functions as a notification issuing unit which issues a start condition to the slave device 20 side at the subsequent stage of the bus connection control circuit 30 before the bus connection ON/OFF circuit 308 connects the serial bus (first bus) 40 at the previous stage of the bus connection control circuit 30 and the serial bus (second bus) 40 at the subsequent stage thereof.

The switch (SW) 310 freely switches the clock signal line 41 at the previous stage of the bus connection control circuit 30 and the clock signal line 41 at the subsequent stage thereof between a connected state and a disconnected state. The switch (SW) 311 freely switches the data signal line 42 at the previous stage of the bus connection control circuit 30 and the data signal line 42 at the subsequent stage thereof between a connected state and a disconnected state. These switches 310 and 311 switch the signal lines 41 and 42, respectively, between connection and disconnection by following the control by the bus connection ON/OFF circuit 308 described below.

The bus connection ON/OFF circuit 308 controls the switch 310 to switch between connection and disconnection of the clock signal line 41 at the previous stage of the bus connection control circuit 30 and the clock signal line 41 at the subsequent stage thereof. Also, the bus connection ON/OFF circuit 308 controls the switch 311 to switch between connection and disconnection of the data signal line 42 at the previous stage of the bus connection control circuit 30 and the data signal line 42 at the subsequent stage thereof. That is, the bus connection ON/OFF circuit 308 functions as a connection control unit which controls connection and disconnection of the serial bus (first bus) 40 at the previous stage of the bus connection control circuit 30 and the serial bus (second bus) 40 at the subsequent stage thereof.

The bus connection ON/OFF circuit 308 connects the clock signal lines 41 and the data signal lines 42 at the previous stage and the subsequent stage of the bus connection control circuit 30 after the start condition generation circuit 307 generates a start condition on the slave device 20 side at the subsequent stage of the bus connection control circuit 30. Also, when the stop condition detection circuit 309 detects an occurrence of a stop condition, the bus connection ON/OFF circuit 308 disconnects the clock signal lines 41 and the data signal lines 42 at the previous stage and the subsequent stage of the bus connection control circuit 30.

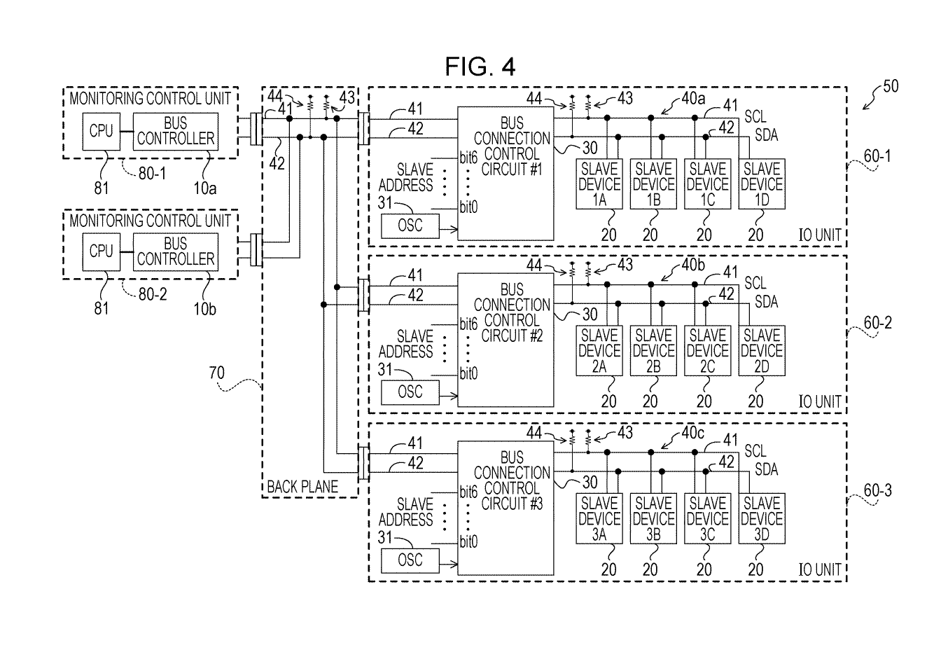

FIG. 4 is a diagram depicting an example of the connection structure of the bus system 1 as an exemplary embodiment. An information processing apparatus 50 exemplarily depicted in FIG. 4 is used as a server computer, and includes a plurality of (two in the example depicted in FIG. 4) monitoring control units 80-1 and 80-2, a back plane 70, and a plurality of (three in the example depicted in FIG. 4) input output (IO) units 60-1 to 60-3. Note that since a reference character identical to the reference character already described represents the same portion in the drawings, detailed description of that portion is omitted herein.

In the information processing apparatus 50 depicted in FIG. 4, with the plurality of monitoring control units 80-1 and 80-2, load distribution and ensured redundancy are attained. The monitoring control unit 80-1 includes a central processing unit (CPU) 81 and the bus controller 10a, and the monitoring control unit 80-2 includes a CPU 81 and the bus controller 10b.

The back plane 70 communicably connects each of the IO units 60-1 to 60-3 to each of the monitoring control units 80-1 and 80-2.

The IO units 60-1 to 60-3 have a similar structure. That is, in the example of the structure of the information processing apparatus 50 depicted in FIG. 4, the plurality of IO units 60 having the similar structure are implemented in one apparatus. In this manner, by providing commonality of the structures of the IO units 60-1 to 60-3, manufacturing cost and management cost of the apparatus may be reduced.

Note that the IO unit 60-1 includes the serial bus 40a and the slave devices 20 denoted as the reference characters 1A, 1B, 1C, and 1D are connected to this serial bus 40a. Also, the IO unit 60-2 includes the serial bus 40b, and the slave devices 20 denoted as the reference characters 2A, 2B, 2C, and 2D are connected to this serial bus 40b. Furthermore, the IO unit 60-3 includes a serial bus 40c, and slave devices 20 denoted as reference characters 3A, 3B, 3C, and 3D are connected to this serial bus 40c.

Note that the bus connection control circuit 30 included in the IO unit 60-1 may be referred to as a bus connection control circuit #1. Similarly, the bus connection control circuit 30 included in the IO unit 60-2 may be referred to as a bus connection control circuit #2, and the bus connection control circuit 30 included in the IO unit 60-3 may be referred to as a bus connection control circuit #3.

In the information processing apparatus 50 exemplarily depicted in FIG. 4, the bus connection control circuit #1, the bus connection control circuit #2, and the bus connection control circuit #3 are connected in parallel to the I2C bus to which the bus controllers 10a and 10b are directly connected.

The slave devices 20 mounted on the IO units 60-1 to 60-3 are, for example, voltage monitors, temperature sensors, log storage EEPROMs, and so forth.

In the information processing apparatus 50 exemplarily depicted in FIG. 4, for example, when the bus controller 10 writes data in the slave device 1A, the bus controller 10 performs data transmission by following sequences (1) to (5) below.
(1) Start condition
(2) First transmission data: the slave address of the bus connection control circuit #1+WRITE
(3) Second transmission data: the slave address of the slave device 1A+WRITE
(4) Third transmission data: write data to the slave device 1A
(5) Stop condition

Also, for example, when the bus controller 10 writes data in the slave device 2A, the bus controller 10 performs data transmission by following sequences (1) to (5) below.
(1) Start condition
(2) First transmission data: the slave address of the bus connection control circuit #2+WRITE
(3) Second transmission data: the slave address of the slave device 2A+WRITE
(4) Third transmission data: write data to the slave device 2A
(5) Stop condition

Also, for example, when the bus controller 10 writes data in the slave device 3A, the bus controller 10 performs data transmission by following sequences (1) to (5) below.
(1) Start condition
(2) First transmission data: the slave address of the bus connection control circuit #3+WRITE
(3) Second transmission data: the slave address of the slave device 3A+WRITE
(4) Third transmission data: write data to the slave device 3A
(5) Stop condition

Note that, between the start condition and the stop condition in which one bus controller 10 (for example, the bus controller 10a) is using the serial bus 40, another bus controller 10 (for example, the bus controller 10b) is unable to use the serial bus 40. Therefore, in the information processing apparatus 50, an erroneous access due to the multi-master structure or multitasking does not occur.

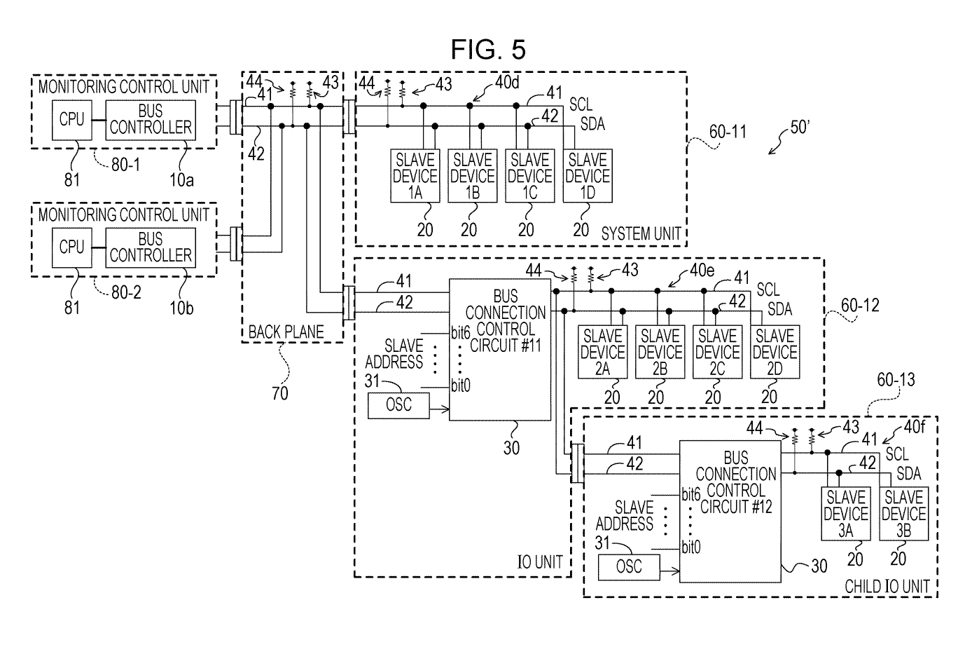

FIG. 5 is a diagram depicting another example of the connection structure of the bus system 1 as an exemplary embodiment. An information processing apparatus 50′ exemplarily depicted in FIG. 5 is also used as a server computer, and includes the plurality of (two in the example depicted in FIG. 5) monitoring control units 80-1 and 80-2, the back plane 70, a system unit 60-11, an IO unit 60-12, and a child IO unit 60-13. Note that since a reference character identical to the reference character already described represents the same portion in the drawings, detailed description of that portion is omitted herein. Also in the information processing apparatus 50′ depicted in FIG. 5, with the plurality of monitoring control units 80-1 and 80-2, load distribution and ensured redundancy are attained.

The back plane 70 communicably connects each of the system unit 60-11 and the IO unit 60-12 to each of the monitoring control units 80-1 and 80-2.

Note that the system unit 60-11 includes a serial bus 40d, and the slave devices 20 denoted as the reference characters 1A, 1B, 1C, and 1D are connected to this serial bus 40d. Also, the IO unit 60-12 includes a serial bus 40e, and the slave devices 20 denoted as the reference characters 2A, 2B, 2C, and 2D are connected to this serial bus 40e. Furthermore, the child IO unit 60-13 includes a serial bus 40f, and the slave devices 20 denoted as the reference characters 3A and 3B are connected to this serial bus 40f.

Note that the bus connection control circuit 30 included in the IO unit 60-12 may be referred to as a bus connection control circuit #11. Similarly, the bus connection control circuit 30 included in the child IO unit 60-13 may be referred to as a bus connection control circuit #12. Note that the system unit 60-11 does not include a bus connection control circuit 30. An information processing apparatus such as a server may be configured to have a child IO unit such as a daughter-card implemented in an IO unit.

In the information processing apparatus 50′ depicted in FIG. 5, the child IO unit 60-13 is configured as a child IO unit (daughter-card) of the IO unit 60-12. With this, the bus connection control circuit #11 is connected to the serial bus 40d to which the bus controllers 10a and 10b are directly connected, and the bus connection control circuit #12 is connected to the serial bus 40e at the subsequent stage of the bus connection control circuit #11. That is, the information processing apparatus 50′ has a connection structure in which the bus connection control circuit #11 and the bus connection control circuit #12 are connected in serial.

The slave devices 20 mounted on the system unit 60-11, the IO unit 60-12, and the child IO unit 60-13 are, for example, voltage monitors, temperature sensors, log storage EEPROMs, and so forth.

In the information processing apparatus 50′ exemplarily depicted in FIG. 5, for example, when the bus controller 10 writes data in the slave device 2A, the bus controller 10 performs data transmission by following sequences (1) to (5) below.
(1) Start condition
(2) First transmission data: the slave address of the bus connection control circuit #11+WRITE
(3) Second transmission data: the slave address of the slave device 2A+WRITE
(4) Third transmission data: write data to the slave device 2A
(5) Stop condition

Also, for example, when the bus controller 10 writes data in the slave device 3A, the bus controller 10 performs data transmission by following sequences (1) to (6) below.
(1) Start condition
(2) First transmission data (first): the slave address of the bus connection control circuit #11+WRITE
(3) First transmission data (second): the slave address of the bus connection control circuit #12+WRITE
(4) Second transmission data: the slave address of the slave device 3A+WRITE
(5) Third transmission data: write data to the slave device 3A
(6) Stop condition

Note that, also in the information processing apparatus 50′, between the start condition and the stop condition in which one bus controller 10 (for example, the bus controller 10a) is using the serial bus 40, another bus controller 10 (for example, the bus controller 10b) is unable to use the serial bus 40. Therefore, also in the information processing apparatus 50′, an erroneous access due to the multi-master structure or multitasking does not occur.

[Operation]

Bus connection control by the bus connection control circuit 30 of the bus system 1 as an exemplary embodiment configured as described above is described by using timing diagrams depicted in FIG. 3A to FIG. 3D.

When the clock signal SCL is in a H level state, the start condition detection circuit 303 detects a state in which the data signal SDA falls from a H level to a low (L) level as a start condition of the I2C bus (refer to a time T1).

The slave address comparison circuit 304 compares the slave address included in the first transmission data transmitted from the bus controller 10 and the address set by the slave address setting input to determine whether these address match.

The data signal high detection circuit 305 detects whether the data signal SDA at the subsequent stage of the bus connection control circuit 30 is at a H level.

The slave address comparison circuit 304 acquires the slave address included in the first transmission data transmitted from the bus controller 10.

Note that FIG. 3A to FIG. 3D depict an example in which “55 (hexadecimal number)” is set to the bus connection control circuit 30 as a slave address. In the example depicted in FIG. 3A and FIG. 3B, at reception of the first transmission data, a slave address value “1010101” is read from the data signal SDA at a timing of rising of each of clocks represented as “6 bit” to “Obit” in the clock signal SCL. Also, “0” representing Write is read from the data signal SDA at a timing represented as “R/W” in the clock signal SCL.

The slave address comparison circuit 304 compares the slave address included in the first transmission data transmitted from the bus controller 10 in this manner and the address set by the slave address setting input to determine whether these addresses match. Then, when these addresses match, if the data signal high detection circuit 305 detects that the data signal SDA at the subsequent stage of the bus connection control circuit 30 is at a H level, the response circuit 306 sends an ACK signal to the bus controller 10. This response with the ACK signal is performed at a timing represented as “ack” in the clock signal SCL depicted in FIG. 3A (refer to a time T2).

Then, a start condition is detected at the subsequent stage of the bus connection control circuit 30 (refer to a time T3), and the clock signal line 41 and the bus connection control circuit 30 are connected between the previous stage and the subsequent stage of the bus connection control circuit 30 (refer to a time T4).

Between the bus controller 10 and the slave device 20, data transmission and reception and so forth are performed. Then, the stop condition detection circuit 309 detects an occurrence of a stop condition. That is, when the clock signal SCL and the data signal SDA each become at a H level, the bus connection ON/OFF circuit 308 disconnects each of the clock signal line 41 and the data signal line 42 at the previous stage and the subsequent stage in the bus connection control circuit 30 (refer to a time T5). This causes a bus disconnection state between the previous stage and the subsequent stage of the bus connection control circuit 30.

In the bus system 1, detection of a start condition at the time T1 to detection of a stop condition at the time T5 are performed in one bus cycle.

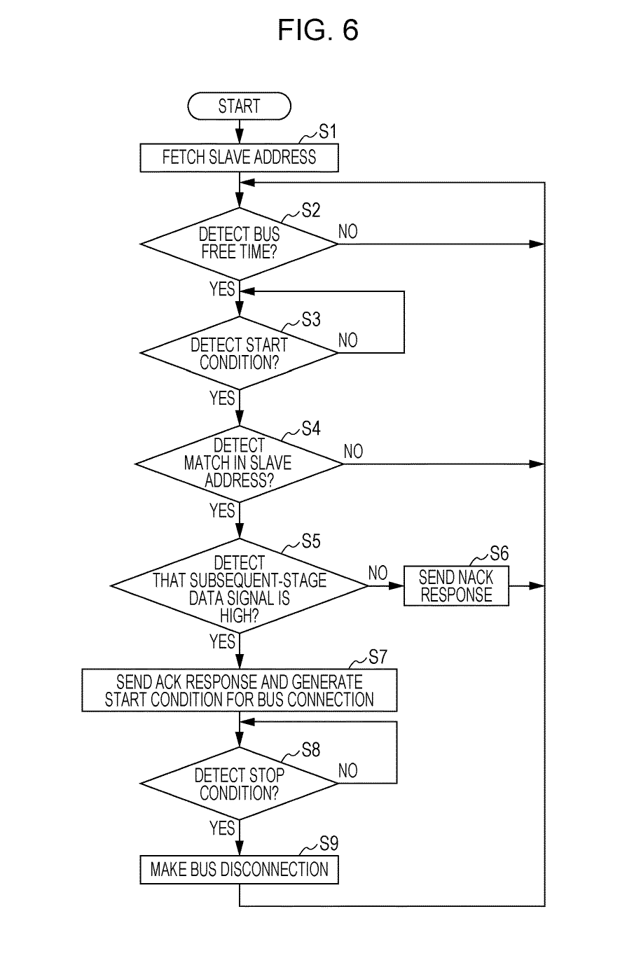

FIG. 6 is a flowchart for describing a process by the bus connection control circuit 30 of the bus system 1 as an exemplary embodiment. At power-up of the bus controller 10 (the bus connection control circuit 30 and the information processing apparatuses 50 and 50′), the address input circuit 301 fetches the value of the slave address set by the external input pins of the bus connection control circuit 30 (operation S1).

At operation S2, the BFT detection circuit 302 determines whether voltage levels of both of the clock signal line 41 and the data signal line 42 are in a H level state for a predetermined time (Tbuf). When the voltage levels of both of the clock signal line 41 and the data signal line 42 are not in a H level state for the predetermined time (Tbuf) (refer to a No route of operation S2), the procedure repeatedly performs operation S2. When the BFT detection circuit 302 detects that the voltage levels of both of the clock signal line 41 and the data signal line 42 are in a H level state for the predetermined time (Tbuf) (refer to a Yes route of operation S2), the procedure proceeds to operation S3.

At operation S3, the start condition detection circuit 303 checks whether to detect a start condition of the I2C bus. If the start condition detection circuit 303 does not detect a start condition (refer to a No route of operation S3), the procedure repeatedly performs operation S3. When the start condition detection circuit 303 detects a start condition (refer to a Yes route of operation S3), the procedure proceeds to operation S4.

At operation S4, the slave address comparison circuit 304 compares the slave address included in the first transmission data transmitted from the bus controller 10 and the slave address fetched by the address input circuit 301 to determine whether these address values are identical. When the slave address included in the first transmission data transmitted from the bus controller 10 and the slave address fetched by the address input circuit 301 do not match (refer to a No route of operation S4), the procedure returns to operation S2.

When the slave address included in the first transmission data transmitted from the bus controller 10 and the slave address fetched by the address input circuit 301 match (refer to a Yes route of operation S4), the procedure proceeds to operation S5.

At operation S5, the data signal high detection circuit 305 checks whether the data signal SDA at the subsequent stage of the bus connection control circuit 30 is at a H level. When the data signal SDA at the subsequent stage of the bus connection control circuit 30 is not at a H level but at a L level (refer to a No route of operation S5), the procedure proceeds to operation S6.

At operation S6, the response circuit 306 sends a NACK signal to the bus controller 10, and the procedure returns to operation S2. Also, when the data signal high detection circuit 305 determines that the data signal SDA at the subsequent stage of the bus connection control circuit 30 is at a H level (refer to a Yes route of operation S5), the procedure proceeds to operation S7.

At operation S7, the response circuit 306 sends an ACK signal to the bus controller 10. Also, the start condition generation circuit 307 generates a start condition on the slave device 20 side at the subsequent stage of the bus connection control circuit 30. Furthermore, the bus connection ON/OFF circuit 308 connects the serial bus 40 at the previous stage of the bus connection control circuit 30 and the serial bus 40 at the subsequent stage thereof.

Thereafter, communication is allowed between the bus controller 10 and the slave device 20 on the downstream side of the bus connection control circuit 30. That is, to the slave device 20 as an access destination included in the second transmission data transmitted from the bus controller 10, process target data included in the third transmission data is transmitted, and is processed by the slave device 20. Then at operation S8, the stop condition detection circuit 309 determines whether to detect a stop condition of the I2C bus.

If the stop condition detection circuit 309 does not detect a stop condition (refer to a No route of operation S8), the stop condition detection circuit 309 repeatedly performs operation S8 until a stop condition is detected. When the stop condition detection circuit 309 detects a stop condition (refer to a Yes route of operation S8), the procedure proceeds to operation S9.

At operation S9, the bus connection ON/OFF circuit 308 disconnects each of the clock signal line 41 and the data signal line 42 at the previous stage and the subsequent stage of the bus connection control circuit 30 to cut off the serial bus 40b. Then, the procedure returns to operation S2.

[Effects]

When accessing the slave device 20 connected to the serial bus 40b via the bus connection control circuit 30, the bus controller 10 transmits first transmission data, second transmission data, and third transmission data.

The first transmission data includes a slave address set to the bus connection control circuit 30. In the bus connection control circuit 30, the slave address comparison circuit 304 compares the slave address included in the first transmission data transmitted from the bus controller 10 and the address set by a slave address setting input to determine whether these addresses are identical.

When these address match, a start condition is issued from the start condition generation circuit 307 to the downstream side, bus connection is performed by the bus connection ON/OFF circuit 308, and bus communication is allowed between the previous stage and the subsequent stage of the bus connection control circuit 30.

Then, by using the second transmission data and the third transmission data, a process from the bus controller 10 on the slave device 20 is performed. That is, only by transmitting the first transmission data, the second transmission data, and the third transmission data from the bus controller 10, the slave device 20 becomes accessible in one bus cycle. Therefore, unlike the related art using a bus multiplexer, two-step access including channel selection of the bus multiplexer from the bus controller (first access) and an access to the slave device (second access) does not have to be performed.

In the bus system 1 as an exemplary embodiment, the slave devices 20 are connected to the bus controller 10 via the bus connection control circuit 30. Also, in the bus connection control circuit 30, before the bus connection ON/OFF circuit 308 connects the serial bus 40 at the previous stage of the bus connection control circuit 30 and the serial bus 40 at the subsequent stage thereof, the start condition generation circuit 307 causes the serial bus 40 at the subsequent stage of the bus connection control circuit 30 to generate a start condition.

With this, in one bus cycle without issuance of a stop condition to the slave device 20, the bus controller 10 is able to access the slave device 20. Since the slave device 20 is accessible from the bus controller 10 in one bus cycle, an erroneous access to the slave device 20 due to channel control of the bus multiplexer with a multi-master structure with a plurality of bus controllers 10 does not occur.

Between the start condition and the stop condition in which one bus controller 10 (for example, the bus controller 10a) is using the serial bus 40, that is, during one bus cycle, another bus controller 10 (for example, the bus controller 10b) is not allowed to use the serial bus 40. Therefore, in the multi-master structure, in the course of an access by one bus controller 10 to the slave device 20, a bus access by another bus controller 10 is disabled, and an erroneous access does not occur.

Also, even in a single master structure with one bus controller 10, when firmware operates in a multitasking manner, as with the case of a multi-master structure, an erroneous access to the slave device 20 due to channel control between a plurality of tasks is disabled. That is, in the course of an access by one task to the slave device 20, a bus access by another task is disabled, and an erroneous access does not occur.

The slave address comparison circuit 304 compares the slave address included in the first transmission data transmitted from the bus controller 10 and the address set by the slave address setting input to determine whether these address match. This allows a determination as to whether the data transmitted from the bus controller 10 is for the slave device 20 belonging to the bus connection control circuit 30.

Also, in the bus connection control circuit 30, before the bus connection ON/OFF circuit 308 connects the serial bus 40 at the previous stage of the bus connection control circuit 30 and the serial bus 40 at the subsequent stage thereof, the data signal high detection circuit 305 detects whether the data signal SDA at the subsequent stage of the bus connection control circuit 30 is at a H level. Then, when the data signal SDA at the subsequent stage of the bus connection control circuit 30 is at a L level, the response circuit 306 sends a NACK signal to the bus controller 10 side. When receiving the NACK signal from the response circuit 306, the bus controller 10 ends the access to the slave device 20 at the subsequent stage of the bus connection control circuit 30. This may cause the bus controller 10 not to be connected to the serial bus 40 falling to a L level and avoid an inability to control the slave device 20 from the bus controller 10.

[Others]

The technology disclosed herein is not restricted to the embodiments described above, and may be implemented by being variously modified without deviating from the gist of the embodiments. Each structure and each process of the embodiments may be selected as desired, or may be combined as appropriate. For example, in the above-described embodiments, the example is depicted in which the bus system 1 is an I2C bus. However, the bus system 1 is not restricted to this, and may be a bus system of another standard.

Also, in the information processing apparatus 50 depicted in FIG. 4, the IO units 60-1 to 60-3 have a similar structure, and the IO units 60-1 to 60-3 each includes the bus connection control circuit 30. However, this is not meant to be restrictive. For example, the bus connection control circuit 30 of the IO unit 60-1 may be omitted. Also, at least part of the functions as the address input circuit 301, the BFT detection circuit 302, the start condition detection circuit 303, the slave address comparison circuit 304, the data signal high detection circuit 305, the response circuit 306, the start condition generation circuit 307, the bus connection ON/OFF circuit 308, and the stop condition detection circuit 309 in the bus connection control circuit 30 described above may be implemented by a program.

Note that a program for implementing functions as the address input circuit 301, the BFT detection circuit 302, the start condition detection circuit 303, the slave address comparison circuit 304, the data signal high detection circuit 305, the response circuit 306, the start condition generation circuit 307, the bus connection ON/OFF circuit 308, and the stop condition detection circuit 309 is provided in a form of, for example, being recorded on a computer-readable recording medium such as a flexible disk, a CD (such as CD-ROM, CD-R, or CD-RW), DVD (DVD-ROM, DVD-RAM, DVD-R, DVD+R, DVD-RW, DVD+RW, or HD DVD), Blu-ray disk, magnetic disk, optical disk, or magneto-optical disk. Then, a computer reads the program from the recording medium, transfers and stores the program to an internal storage apparatus or external storage apparatus, and uses the program. Also, the program may be recorded on a storage apparatus (recording medium) such as a magnetic disk, optical disk, or magneto-optical disk, for example, and may be provided from the storage apparatus via a communication route to the computer.

To implement the functions as the address input circuit 301, the BFT detection circuit 302, the start condition detection circuit 303, the slave address comparison circuit 304, the data signal high detection circuit 305, the response circuit 306, the start condition generation circuit 307, the bus connection ON/OFF circuit 308, and the stop condition detection circuit 309, a program stored in an inner storage apparatus (for example, random access memory (RAM) or read only memory (ROM)) is executed by a microprocessor (for example, CPU) of the computer. Here, the program recorded on the recording medium may be read and executed by the computer.

Also, the processor may be a multiprocessor. The processor may be, for example, any one of a CPU, micro processing unit (MPU), digital signal processor (DSP), application specific integrated circuit (ASIC), programmable logic device (PLD), and field programmable gate array (FPGA). Also, with the above-described disclosure, the embodiments may be implemented and manufactured by a person skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay apparatus configured to relay data transmitted on a first bus coupled to a bus controller and a second bus coupled to a device, the relay apparatus comprising:
a memory; and
a processor coupled to the memory and the processor configured to:
control a switch to couple or separate the first bus and the second bus, and
transmit first data for indicating a bus access start to the second bus before coupling the first bus and the second bus.

2. The relay apparatus according to claim 1,
wherein the processor is further configured to:
compare a first address set to the relay apparatus and a second address of the relay apparatus included in a first transmission data transmitted from the bus controller, and
wherein, when the first address and the second address match, the processor controls the switch to couple the first bus and the second bus.

3. The relay apparatus according to claim 1,
wherein the processor is further configured to:
monitor a voltage level of data on the second bus, and
transmit a second data for indicating a negative acknowledgement (NACK) signal to the first bus when the voltage level is a low level.

4. The relay apparatus according to claim 2,
wherein the processor is further configured to:
monitor a voltage level of data on the second bus, and
transmit a second data for indicating a negative acknowledgement (NACK) signal to the first bus when the voltage level is a low level.

5. A relay method of a relay apparatus that relays data transmitted on a first bus couples to a bus controller and a second bus coupled to a device, the relay method comprising:
transmitting first data for indicating a bus access start to the second bus; and
controlling a switch to couple the first bus and the second bus, by a processor.

6. The relay method according to claim 5, further comprising:
receiving first transmission data that includes an address of the relay apparatus and that is transmitted from the bus controller;
comparing the address included in the first transmission data and an address set to the relay apparatus; and
coupling the first bus and the second bus when the address included in the first transmission data and the address set to the relay apparatus match, by the processor.

7. The relay method according to claim 5, further comprising:
monitoring a voltage level of data on the second bus; and
transmitting a second data for indicating a negative acknowledgement (NACK) signal to the first bus when the voltage level is a low level, by the processor.

8. The relay method according to claim 6, further comprising:
monitoring a voltage level of data on the second bus; and
transmitting a second data for indicating a negative acknowledgement (NACK) signal to the first bus when the voltage level is a low level, by the processor.

9. A computer-readable non-transitory recording medium storing a program that causes a computer to execute a procedure of a relay apparatus that relays data transmitted on a first bus couples to a bus controller and a second bus coupled to a device, the procedure comprising:
transmitting first data for indicating a bus access start to the second bus; and
controlling a switch to couple the first bus and the second bus.

10. The computer-readable non-transitory recording medium according to claim 9,
wherein the procedure further comprises:
receiving first transmission data that includes an address of the relay apparatus and that is transmitted from the bus controller;
comparing the address included in the first transmission data and an address set to the relay apparatus; and
coupling the first bus and the second bus when the address included in the first transmission data and the address set to the relay apparatus match.

11. The computer-readable non-transitory recording medium according to claim 9,
wherein the procedure further comprises:
monitoring a voltage level of data on the second bus; and
transmitting a second data for indicating a negative acknowledgement (NACK) signal to the first bus when the voltage level is a low level.

12. The computer-readable non-transitory recording medium according to claim 10,
wherein the procedure further comprises:
monitoring a voltage level of data on the second bus; and
transmitting a second data for indicating a negative acknowledgement (NACK) signal to the first bus when the voltage level is a low level.
